(19) United States
(12) Patent Application Publication
(10) Pub. No.: US 2023/0317360 A1
(43) Pub. Date: Oct. 5, 2023

(54) MULTILAYER INDUCTOR

(71) Applicant: TDK CORPORATION, Tokyo (JP)

(72) Inventors: Kazuya TOBITA, Tokyo (JP); Xuran GUO, Tokyo (JP); Youichi KAZUTA, Tokyo (JP); Yuichi TAKUBO, Tokyo (JP); Yuto SHIGA, Tokyo (JP); So KOBAYASHI, Tokyo (JP); Toshinori MATSUURA, Tokyo (JP); Noriaki HAMACHI, Tokyo (JP); Junichiro URABE, Tokyo (JP); Shunya SUZUKI, Tokyo (JP)

(73) Assignee: TDK CORPORATION, Tokyo (JP)

(21) Appl. No.: 18/187,813

(22) Filed: Mar. 22, 2023

(30) Foreign Application Priority Data
Mar. 29, 2022 (JP) 2022-053851

(51) Int. Cl. H01F 27/29; H01F 17/00; H01F 27/28

(52) U.S. Cl. CPC H01F 27/292; H01F 17/0013; H01F 27/2804; H01F 2017/002; H01F 2027/2809

(57) ABSTRACT

In the multilayer inductor, the extending direction of the connection portion is a direction along the turn portion when viewed from the extending direction of the coil axis. In this case, the change of the current route at the junction portion between the turn portion and the connection portion becomes gentle. Therefore, the signal loss at the junction portion is reduced, a high Q value can be achieved.

### CROSS-REFERENCE TO RELATED APPLICATIONS

This application is based upon and claims the benefit of priority from Japanese Patent Application No. 2022-53851, filed on 29 Mar. 2022, the entire contents of which are incorporated herein by reference.

### TECHNICAL FIELD

The present disclosure relates to a multilayer inductor.

### BACKGROUND

Patent Document 1 below discloses a multilayer inductor provided with a coil conductor having a coil axis parallel to a mounting surface of an element body. In the multilayer inductor disclosed in this document, the element body is constituted by a plurality of insulating layers laminated along the extending direction of the coil axis, and the coil conductor is constituted by a plurality of inductor conductor layers laminated via the insulating layer and a via-hole conductor penetrating through the insulating layer.

### PATENT DOCUMENT

Patent Document 1: WO2016/006542

### SUMMARY

In the above-described multilayer inductor according to the related art, since the plurality of insulating layers are laminated along the extending direction of the coil axis, the length of the via-hole conductor interposed between the adjacent inductor conductor layers is limited to the thickness of the insulating layer, and the direction thereof is limited to the thickness direction of the insulating layer (that is, the extending direction of the coil axis). Hence, it is difficult to adjust the distance between the adjacent inductor conductor layers, and the degree of freedom in designing the number of coil turns is low. Therefore, it is difficult to adjust (for example, increase) an inductance value.

Therefore, the inventors have repeatedly studied a technique in which a distance between adjacent inductor conductor layers can be adjusted by configuring an element body with insulating layers parallel to a coil axis, and thus an inductance value can be adjusted. As a result of this study, it was found that when the current route is bent by 90 degrees at the junction portion between the inductor conductor layer and the via-hole conductor when viewed from a direction perpendicular to the mounting surface as in the above-described multilayer inductor according to the related art, the current route changes abruptly, signal loss occurs at the junction portion, and the Q value may decrease.

According to the present disclosure, a multilayer inductor having an improved Q value is provided.

The multilayer inductor includes an element body having a multilayer structure in which a plurality of insulating layers are laminated and having a mounting surface parallel to the insulating layers, a pair of terminal electrodes provided on the mounting surface of the element body, and a coil conductor provided in the element body, the coil conductor having a coil axis parallel to the mounting surface and having both end portions exposed from the mounting surface and electrically connected to the pair of terminal electrodes. The coil conductor includes an outer peripheral coil portions wound on an outer peripheral side and inner peripheral coil portions wound on an inner peripheral side when viewed from an extending direction of the coil axis, and the outer peripheral coil portions and the inner peripheral coil portions are alternately wound in the coil conductor. The coil conductor includes a plurality of tiers of turn portions arranged along the coil axis, and at least some of the tiers of the turn portions are located in a plane perpendicular to the coil axis and include a first coil portion constituting a part of the outer peripheral coil portion and a second coil portion constituting a part of the inner peripheral coil portion. The end portion of the first coil portion and the end portion of the second coil portion of adjacent tiers of the turn portions are shifted from each other in a direction parallel to the mounting surface when viewed from the extending direction of the coil axis. The coil conductor further includes a connection portion linearly extending between the end portions of the first coil portions or between the end portions of the second coil portions of adjacent tiers of the turn portions and connecting the end portions to each other.

In the above multilayer inductor, the extending direction of the connection portion is not the direction parallel to the coil axis but a direction along the turn portion. Therefore, the current route at the junction portion between the turn portion and the connection portion changes gently, thereby reducing signal loss at the junction portion and improving the Q value.

In the multilayer inductor according to another aspect, the coil conductor has three or more tiers of turn portions and has a plurality of connection portions connecting the end portions of the first coil portions or the end portions of the second coil portions of adjacent tiers of the turn portions.

In the multilayer inductor according to another aspect, a shift amount of both end portions of the connection portion is 1 to 3 times a length of the turn portion in the extending direction of the coil axis.

In the multilayer inductor according to another aspect, each of both end portions of the coil conductor extends from the outer peripheral coil portions and reaches the mounting surface.

### BRIEF DESCRIPTION OF THE DRAWINGS

FIG. 1 is a schematic perspective view showing a multilayer inductor according to one embodiment.

FIG. 2 is a side view of the coil conductor shown in FIG. 1 as viewed from the X direction.

FIG. 3 is a plan view showing the coil conductor shown in FIG. 1.

FIG. 4 is a side view of the coil conductor shown in FIG. 1 as viewed from the Y direction.

FIG. 5 is an exploded perspective view showing a turn portion constituting the coil conductor.

FIG. 6 is a perspective exploded view showing the connection of the turn portions in the coil conductor.

FIG. 7 is a perspective exploded view showing connection of turn portions in the coil conductor.

FIG. 8 is a perspective exploded view showing the connection of the turn portions in the coil conductor.

FIG. 9 is a perspective exploded view showing connection of turn portions in the coil conductor.

FIG. 10 is a perspective exploded view showing the connection of the turn portions in the coil conductor.

FIG. 11 is a view showing a conductor pattern of an insulating layer in which a connection portion is formed.

FIG. 12 is a view showing a conductor pattern of an insulating layer in which a connection portion is formed.

FIG. 13 is a side view showing a coil conductor of another embodiment.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

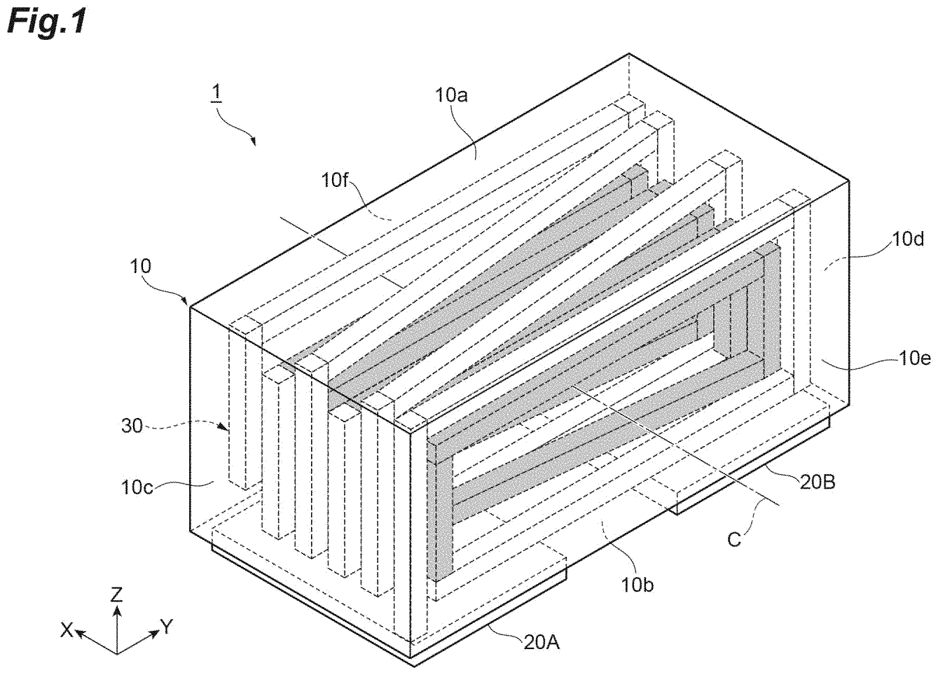

FIG. 1 shows a multilayer inductor 1 according to an embodiment. The multilayer inductor 1 includes an element body 10, a pair of terminal electrodes 20A and 20B provided on the element body 10, and a coil conductor 30 provided inside the element body 10.

The element body 10 has a substantially rectangular parallelepiped outer shape. The element body 10 has an upper surface 10a, a lower surface 10b, a pair of side surfaces 10c and 10d facing each other, and a pair of side surfaces 10e and 10f facing each other. In the present embodiment, the lower surface 10b of the element body 10 is a mounting surface facing a mounting substrate on which the multilayer inductor 1 is mounted. In the present embodiment, the distance between the side surfaces 10c and 10d is longer than the distance between the side surfaces 10e and 10f, and the element body 10 has a shape extending in the facing direction of the side surfaces 10c and 10d. Hereinafter, for convenience of description, a facing direction of the upper surface 10a and the lower surface 10b is also referred to as a Z direction, a facing direction of the side surface 10c and the 10d is also referred to as a Y direction, and a facing direction of the side surface 10e and the 10f is also referred to as an X direction.

The element body 10 has a laminated structure in which a plurality of insulating layers 12 are laminated in the Z direction. The planar shape of each insulating layer 12 (that is, the shape when viewed from the Z direction) is the same shape as the upper surface 10a and the lower surface 10b of the element body 10 (that is, a rectangular shape). The insulating layer 12 is made of an insulating material, for example, a resin. The number of insulating layers 12 is, for example, 9 to 20 (as an example, 12). The thicknesses of the insulating layers 12 are, for example, 0.05 to 0.4 mm (as an example, 0.3 mm), and all of the insulating layers 12 constituting the element body 10 may have the same thicknesses, or some of the insulating layers 12 may have different thicknesses.

The pair of terminal electrodes 20A and 20B are provided on the lower surface 10b of the element body 10. Each of the pair of terminal electrodes 20A and 20B has a rectangular shape. One terminal electrode 20A extends along a short side of the lower surface 10b corresponding to the side surface 10c, and the other terminal electrode 20B extends along a short side of the lower surface 10b corresponding to the side surface 10d. Each of the terminal electrodes 20A and 20B may have a single-layer structure or a multilayer structure.

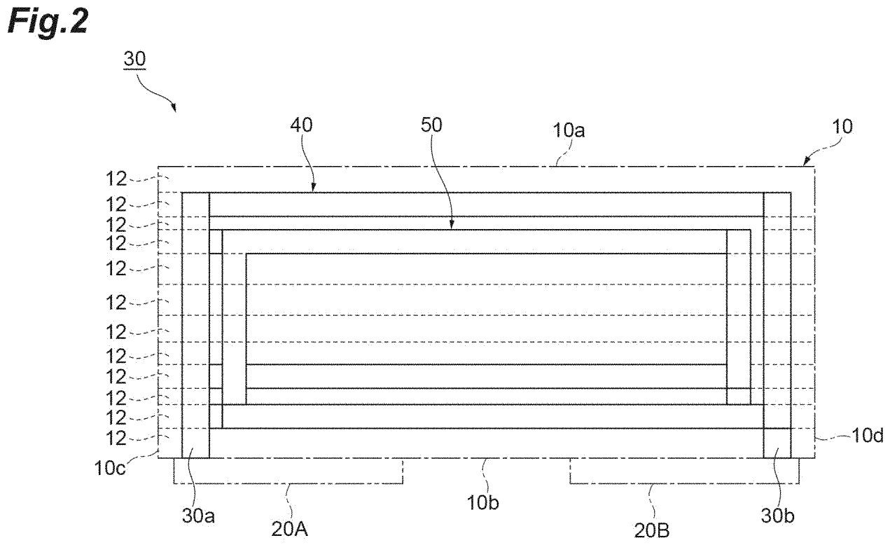

The coil conductor 30 is wound around a coil axis C extending in the X direction. That is, the coil axis C of the coil conductor 30 is parallel to the upper surface 10a and the lower surface 10b of the element body 10 and is parallel to the pair of side surfaces 10c and 10d. As shown in FIG. 2, the coil conductor 30 has a double winding structure and is configured to include outer peripheral coil portions 40 wound on the outer peripheral side and inner peripheral coil portions 50 wound on the inner peripheral side when viewed from the extending direction of the coil axis C. The coil conductor 30 is an aggregate of conductors embedded in the respective insulating layers 12 constituting the element body 10. Therefore, a portion of the coil conductor 30 (an outer pillar, an inner pillar, or the like to be described later) extending in the Z direction is configured by overlapping a plurality of conductors embedded in each of the plurality of insulating layers 12.

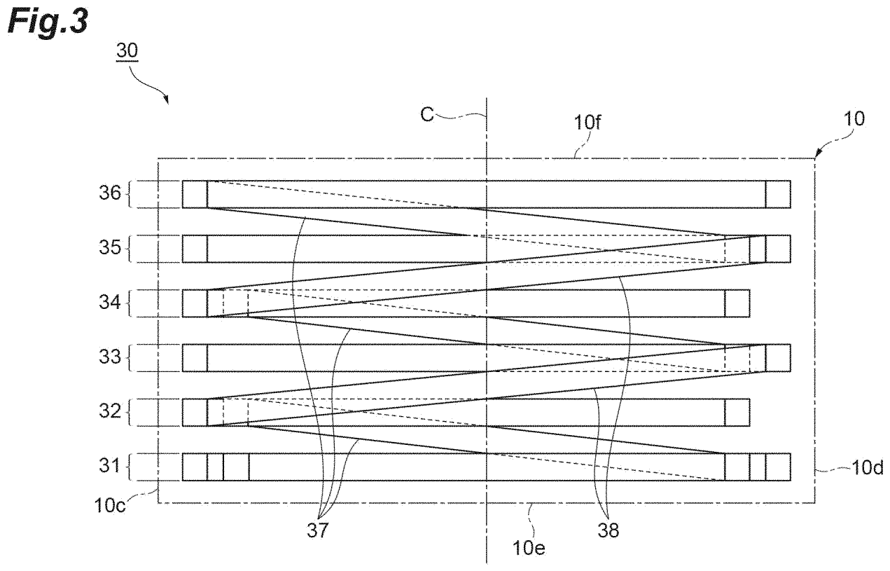

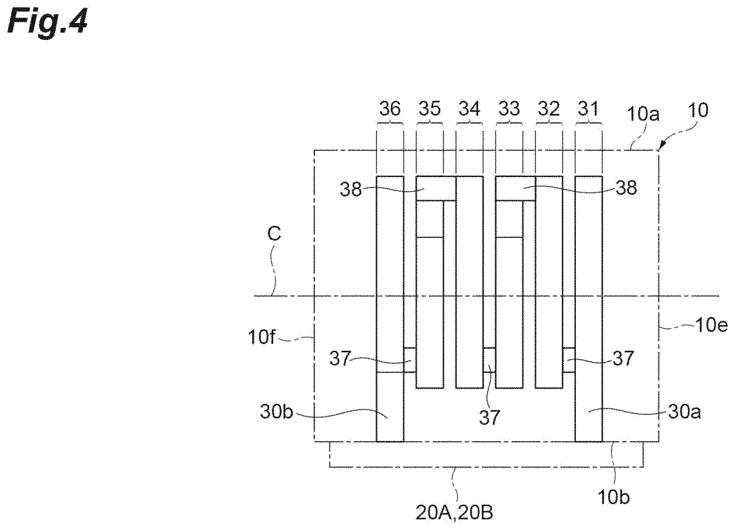

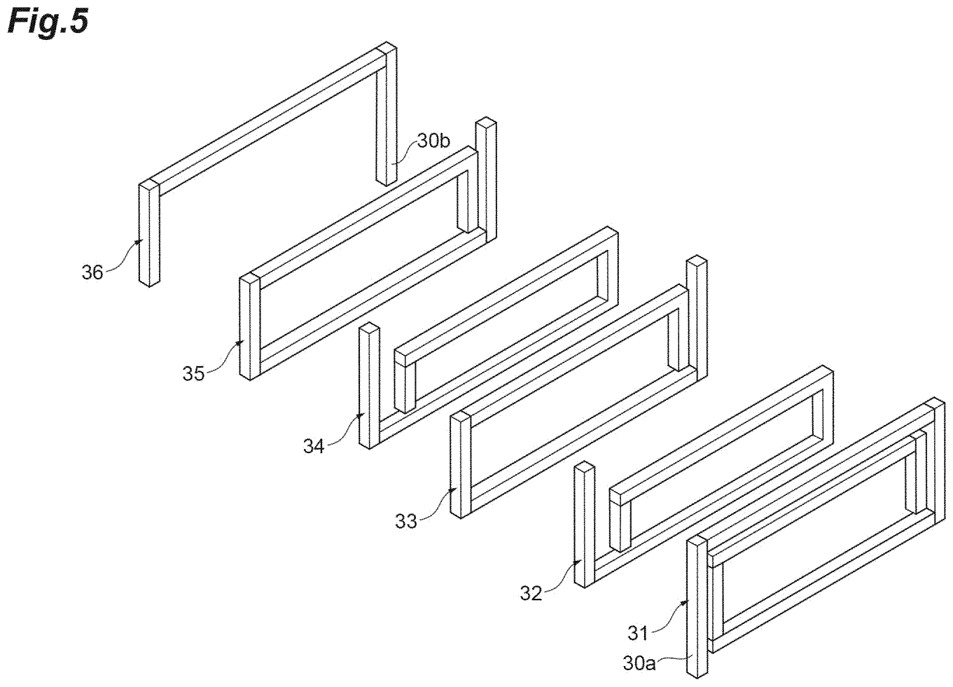

As shown in FIGS. 3 and 4, the coil conductor 30 includes a plurality of tiers (6 tiers in the present embodiment) of turn portions 31 to 36 arranged along the coil axis C. Each of the turn portions 31 to 36 is wound around the coil axis C in a plane (X-Y plane) perpendicular to the coil axis C. The adjacent turn portions 31 to 36 are parallel to each other. As shown in FIG. 5, the turn portions 31 to 36 are arranged in the order of the turn portion 31, the turn portion 32, the turn portion 33, the turn portion 34, the turn portion 35, and the turn portion 36 from the side closer to the side surface 10e. The turn portion 31 closest to the side surface 10e has a coil end portion 30a constituting one end of the coil conductor 30, and the turn portion 36 farthest from the side surface 10e has a coil end portion 30b constituting the other end of the coil conductor 30. Since the element body 10 has a configuration in which the plurality of insulating layers 12 are laminated in the Z direction perpendicular to the coil axis C, the conductor pattern provided in the insulating layer 12 has a high degree of freedom in design, and various dimensions of the turn portions 31 to 36 can be finely designed. For example, the thickness (length in the X direction) of the turn portion and the distance between adjacent turn portions can be arbitrarily designed. Further, the number of tiers of the turn portion can be appropriately 10 increased or decreased without changing the number of layers of the insulation number 12 of the element body 10.

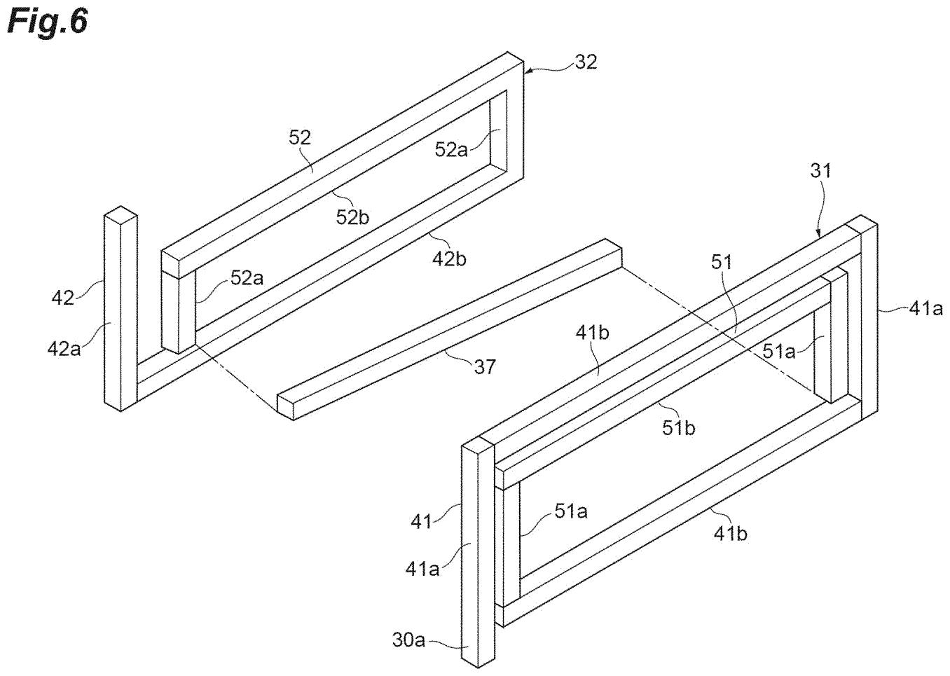

The adjacent turn portions 31 to 36 are connected by connection portions 37 and 38. Hereinafter, the connection of the turn portions 31 to 36 via the connection portions 37 and 38 will be described with reference to FIGS. 6 to 12.

FIG. 6 shows the connection between the turn portion 31 and the turn portion 32 via the connection portion 37.

The turn portion 31 includes a first coil portion 41 constituting a part of the outer peripheral coil portion 40 and a second coil portion 51 continuously extending from the first coil portion 41 and constituting a part of the inner peripheral coil portion 50. The first coil portion 41 includes a pair of outer pillars 41a extending in the Z direction and separated from each other in the Y direction, and a pair of outer cross bars 41b extending in the Y direction and separated from each other in the Z direction, and constitutes one turn of the outer peripheral coil portion. A lower end portion of the outer pillar 41a located on the side surface 10c side of the element body 10 configures a coil end portion 30a, extends to the lower surface 10b, is exposed from the lower surface 10b, and is physically and electrically connected to the terminal electrode 20A. The second coil portion 51 includes a pair of inner pillars 51a extending in the Z direction and separated from each other in the Y direction and one inner cross bar 51b extending in the Y direction, and constitutes ¾ turns of an inner peripheral coil.

The turn portion 32 includes a first coil portion 42 constituting a part of the outer peripheral coil portion 40 and a second coil portion 52 continuously extending from the first coil portion 42 and constituting a part of the inner peripheral coil portion 50. The first coil portion 42 includes one outer pillar 42a extending in the Z direction and one outer cross bar 42b extending in the Y direction, and constitutes ½ turn of the outer peripheral coil portion. The second coil portion 52 includes a pair of inner pillars 52a extending in the Z direction and separated from each other in the Y direction and one inner cross bar 52b that extends in the Y direction, and constitutes ¾ turns of an inner peripheral coil.

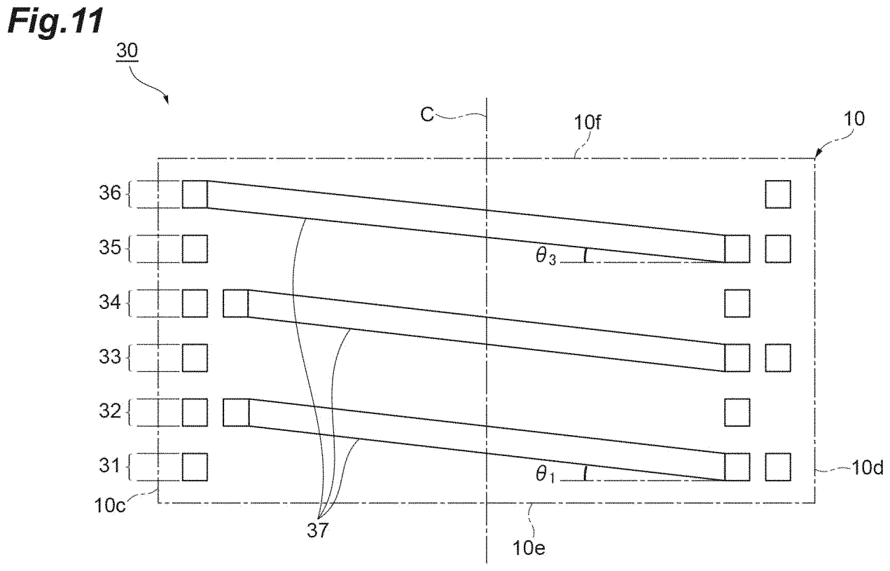

The connection portion 37 has a linear shape. The connection portion 37 connects the second coil portion 51 of the turn portion 31 and the second coil portion 52 of the turn portion 32, which are portions constituting the inner peripheral coil portion 50. More specifically, the connection portion 37 linearly extends between and connects the lower end portion of the inner pillar 51a located on the side surface 10d side of the pair of inner pillars 51a of the second coil portion 51 and the lower end portion of the inner pillar 52a located on the side surface 10c side of the pair of inner pillars 52a of the second coil portion 52. Since the height positions (that is, the positions in the Z direction) of the lower end portions of the inner pillar 51a and the inner pillar 52a to which the connection portion 37 is connected are the same, the connection portion 37 extends perpendicular to the Z direction (that is, parallel to the lower surface 10b). Since the inner pillar 51a and the inner pillar 52a to which the connection portion 37 is connected are shifted in the Y direction when viewed from the extending direction of the coil axis C, the connection portion 37 does not extend in parallel to the X direction but extends so as to intersect the X direction. More specifically, as shown in FIG. 11, when viewed from the Z direction, the connection portion 37 extends in a direction inclined from the Y direction by a slight angle θ₁ (for example, θ₁<45 degrees). The shift amount of the connection portion 37 with respect to the extending direction of the coil axis C is 1 to 3 times (2 times in the present embodiment) length of the turn portions 31 and 32 in the extending direction of the coil axis C. Since the element body 10 has a configuration in which the plurality of insulating layers 12 are laminated in the Z direction perpendicular to the coil axis C, the conductor pattern provided in the insulating layer 12 has a high degree of freedom in design, and various dimensions including the angle θ₁ of the connection portion 37 can be finely designed.

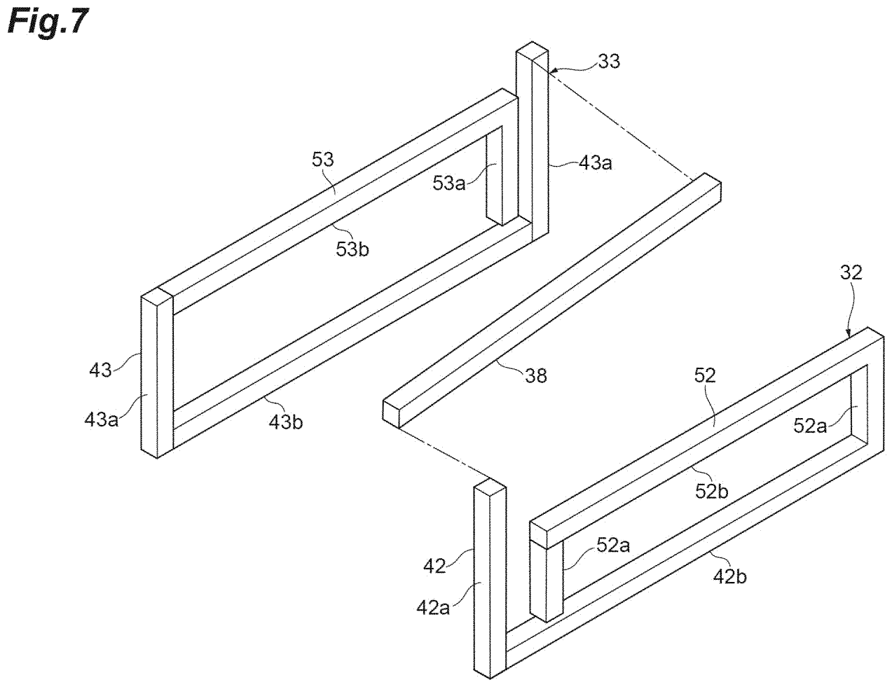

FIG. 7 shows the connection between the turn portion 32 and the turn portion 33 via the connection portion 38.

The turn portion 33 includes a first coil portion 43 constituting a part of the outer peripheral coil portion 40 and a second coil portion 53 continuously extending from the first coil portion 43 and constituting a part of the inner peripheral coil portion 50. The first coil portion 43 includes a pair of outer pillars 43a extending in the Z direction and separated from each other in the Y direction, and one outer cross bar 43b extending in the Y-direction, and constitutes ¾ turns of the outer peripheral coil portion. The second coil portion 53 includes one inner pillar 53a extending in the Z direction and one inner cross bar 53b extending in the Y direction, and constitutes ½ turn of the inner peripheral coil.

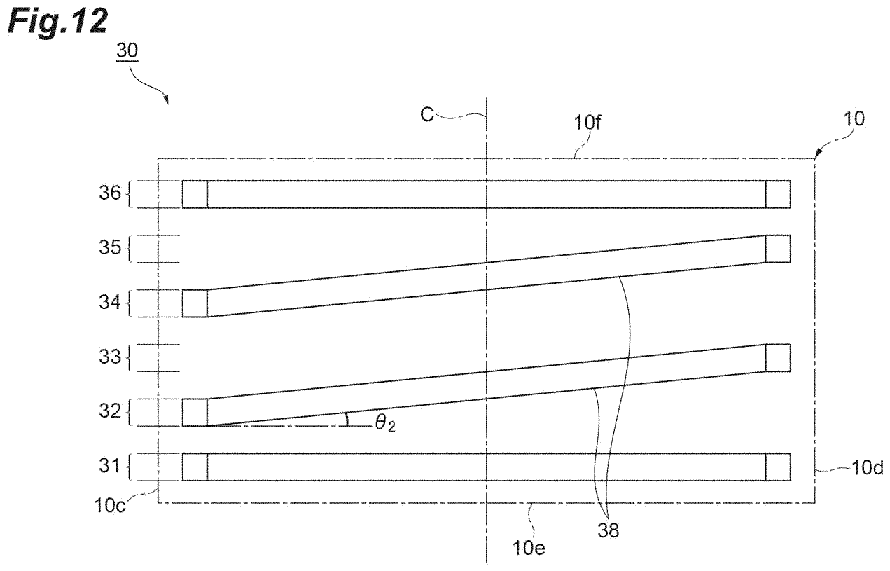

Like the connection portion 37, the connection portion 38 has a linear shape. The connection portion 38 connects the first coil portion 42 of the turn portion 32 and the first coil portion 43 of the turn portion 33, which are portions constituting the outer peripheral coil portion 40. More specifically, the connection portion 38 linearly extends between and connects the upper end portion of the outer pillar 42a of the first coil portion 42 and the upper end portion of the outer pillar 43a located on the side surface 10d side of the pair of outer pillars 43a of the first coil portion 43. Since the height positions of the upper end portions of the outer pillar 42a and the outer pillar 43a to which the connection portion 38 is connected are the same, the connection portion 38 extends perpendicularly to the Z direction. Since the outer pillar 42a and the outer pillar 43a to which the connection portion 38 is connected are shifted in the Y direction when viewed from the extending direction of the coil axis C, the connection portion 38 does not extend in parallel to the X direction but extends so as to intersect the X direction. More specifically, as shown in FIG. 12, when viewed from the Z direction, the connection portion 38 extends in a direction inclined from the Y direction by a slight angle θ₂ (for example, θ2<45 degrees). The shift amount of the connection portion 38 with regard to the extending direction of the coil axis C is 1 to 3 times (2 times in the present embodiment) length of the turn portions 32 and 33 in the extending direction of the coil axis C. Various dimensions including the angle θ₂ of the connection portion 38 can be finely designed similarly to the connection portion 37.

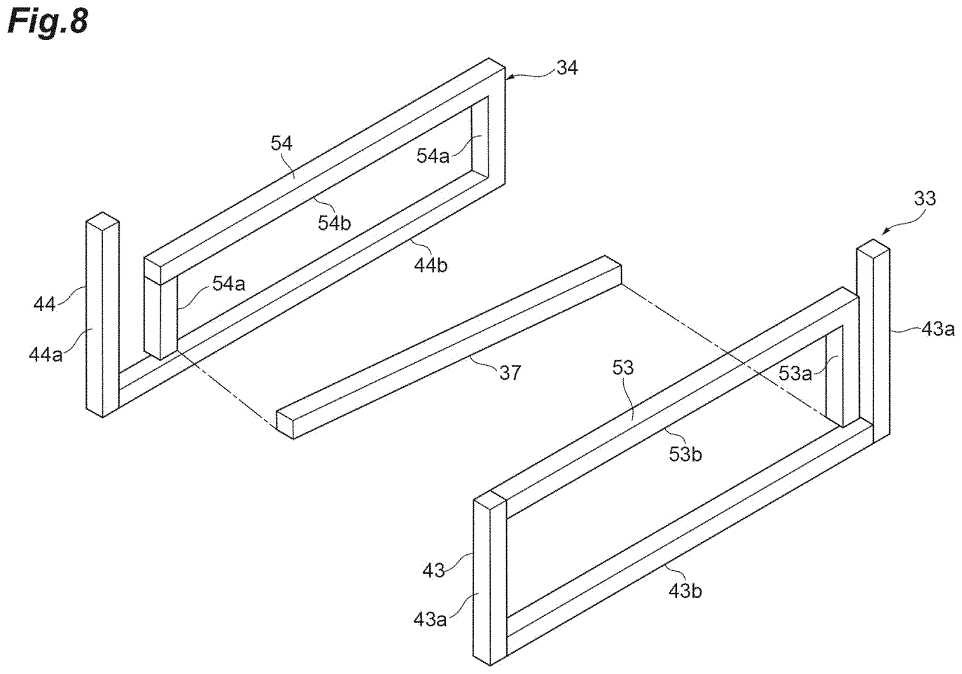

FIG. 8 shows the connection between the turn portion 33 and the turn portion 34 via the connection portion 37. The turn portion 34 has substantially the same shape as that of the above-described turn portion 32. That is, the turn portion 34 includes a first coil portion 44 constituting a part of the outer peripheral coil portion 40 and a second coil portion 54 continuously extending from the first coil portion 44 and constituting a part of the inner peripheral coil portion 50. The first coil portion 44 includes one outer pillar 44a extending in the Z direction and one outer cross bar 44b extending in the Y direction, and constitutes ½ turn of the outer peripheral coil portion. The second coil portion 54 includes a pair of inner pillars 54a extending in the Z direction and separated from each other in the Y direction, and one inner cross bar 54b extending in the Y direction, and constitutes ¾ turns of an inner peripheral coil. The connection portion 37 connecting the turn portion 33 and the turn portion 34 has the same shape and dimensions as the connection portion 37 connecting the turn portion 31 and the turn portion 32. The connection portion 37 connecting the turn portion 33 and the turn portion 34 connects the second coil portion 53 of the turn portion 33 and the second coil portion 54 of the turn portion 34, which are portions constituting the inner peripheral coil portion 50. The configuration in which the connection portion 37 connecting the turn portion 33 and the turn portion 34 connects the second coil portion 53 and the second coil portion 54 are the same as the configuration in which the connection portion 37 connecting the turn portion 31 and the turn portion 32 connects the second coil portion 51 and the second coil portion 52.

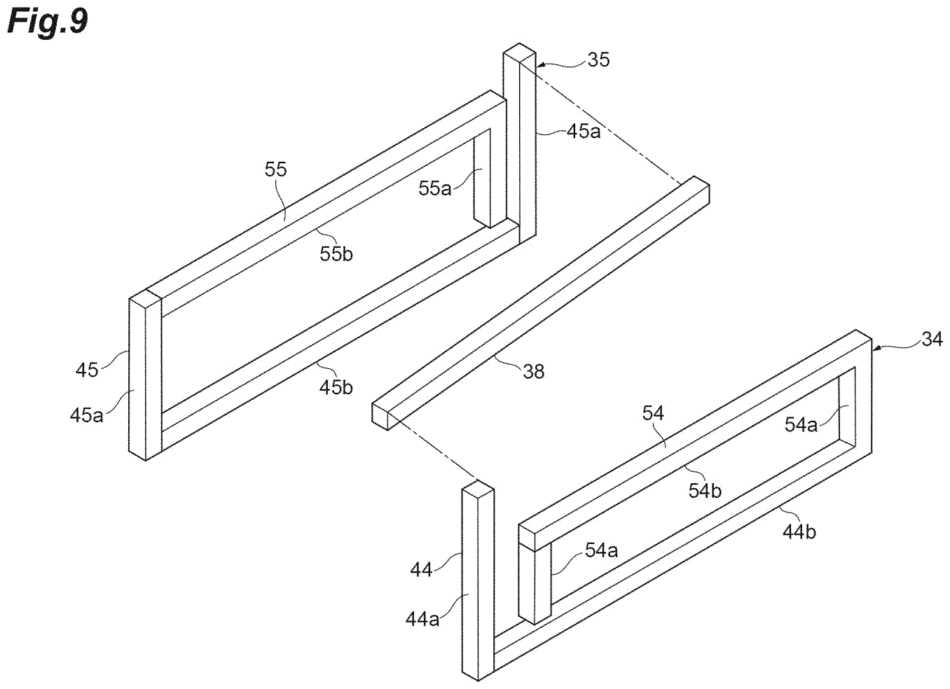

FIG. 9 shows the connection between the turn portion 34 and the turn portion 35 via the connection portion 38. The turn portion 35 has substantially the same shape as that of the above-described turn portion 33. That is, the turn portion 35 includes a first coil portion 45 constituting a part of the outer peripheral coil portion 40 and a second coil portion 55 continuously extending from the first coil portion 45 and constituting a part of the inner peripheral coil portion 50. The first coil portion 45 includes a pair of outer pillars 45a extending in the Z direction and separated from each other in the Y direction, and one outer cross bar 45b extending in the Y-direction, and constitutes ¾ turns of the outer peripheral coil portion. The second coil portion 55 includes one inner pillar 55a extending in the Z direction and one inner cross bar 55b extending in the Y direction, and constitutes ½ turn of the inner peripheral coil. The connection portion 38 that connects the turn portion 34 and the turn portion 35 has the same shape and dimensions as the connection portion 38 connecting the turn portion 32 and the turn portion 33. The connection portion 38 connecting the turn portion 34 and the turn portion 35 connects the first coil portion 44 of the turn portion 34 and the first coil portion 45 of the turn portion 35, which are portions constituting the outer peripheral coil portion 40. The configuration in which the connection portion 38 connecting the turn portion 34 and the turn portion 35 connects the first coil portion 44 and the first coil portion 45 is the same as the configuration in which the connection portion 38 connecting the turn portion 32 and the turn portion 33 connects the first coil portion 42 and the first coil portion 43.

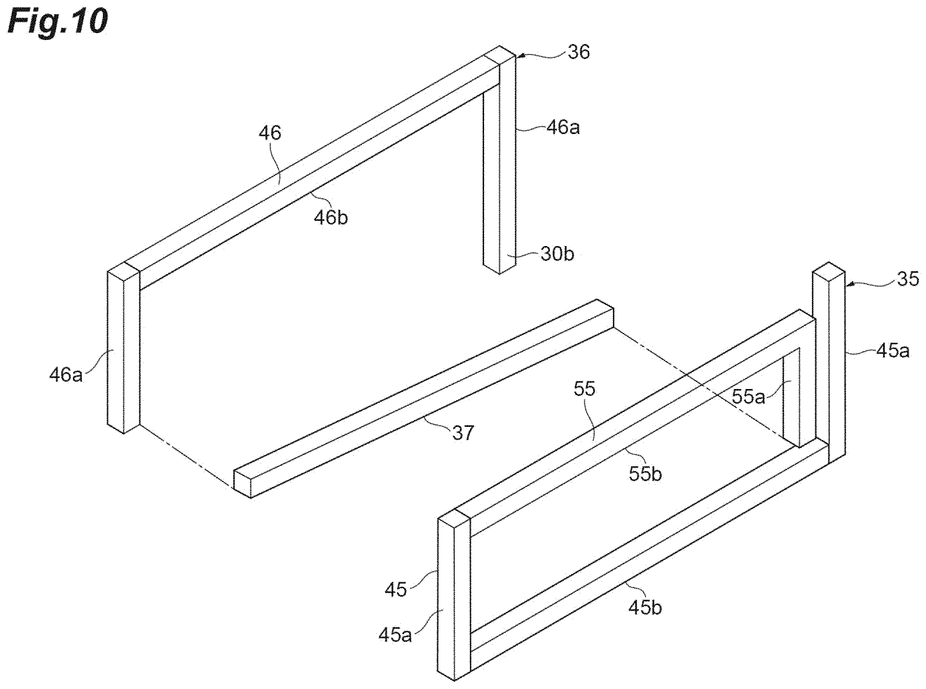

FIG. 10 shows the connection between the turn portion 35 and the turn portion 36 via the connection portion 37. The turn portion 36 has a first coil portion 46 constituting a part of the outer peripheral coil portion 40, and does not have a portion constituting the inner peripheral coil portion 50. The first coil portion 46 includes a pair of outer pillars 46a extending in the Z direction and separated from each other in the Y direction, and one outer cross bar 46b that extends in the Y direction, and constitutes ¾ turns of the outer peripheral coil portion. A lower end portion of the outer pillar 46a located on the side surface 10d side of the element body 10 configures the coil end portion 30b. The coil end portion 30b extends to the lower surface 10b and the coil end portion 30b is exposed from the lower surface 10b and physically and electrically connected to the terminal electrode 20B.

The connection portion 37 connecting the turn portion 35 and the turn portion 36 has a linear shape and connects the second coil portion 55 of the turn portion 35 that is a portion constituting the inner peripheral coil portion 50, and the first coil portion 46 of the turn portion 36 that is a portion constituting the outer peripheral coil portion 40. More specifically, the connection portion 37 linearly extends between a lower end portion of the inner pillar 55a located on the side surface 10d side of the pair of inner pillars 55a of the second coil portion 55 and a lower end portion of the outer pillar 46a located on the side surface 10c side of the pair of outer pillars 46a of the first coil portion 46 and connects the lower end portions. Since the height positions of the lower end portions of the inner pillar 55a and the outer pillar 46a to which the connection portion 37 is connected are the same, the connection portion 37 extends perpendicular to the Z direction. Since the inner pillar 55a and the outer pillar 46a to which the connection portion 37 is connected are shifted in the Y direction when viewed from the extending direction of the coil axis C, the connection portion 37 does not extend in parallel to the X direction but extends to intersect the X direction. More specifically, as shown in FIG. 11, when viewed from the Z direction, the connection portion 37 extends in a direction inclined by a slight angle θ₃ (for example, θ₃<45 degrees). The shift amount of the connection portion 37 in the extending direction of the coil axis C is 1 to 3 times (2 times in the present embodiment) length of the turn portions 35 and 36 in the extending direction of the coil axis C.

The coil conductor 30 is configured such that the turn portions 31 to 36 are connected to each other by the connection portions 37 and 38 as described above. The coil conductor 30 has a configuration in which outer peripheral coil portions 40 and inner peripheral coil portions 50 are alternately wound by the turn portions 31 to 36 and the connection portions 37 and 38. Therefore, when a voltage is applied to the pair of terminal electrodes 20A and 20B and a current flows from one coil end portion 30a to the coil conductor 30, for example, the current flows spirally around the coil axis C and alternately through the outer peripheral coil portions 40 and the inner peripheral coil portions 50.

In the above-described multilayer inductor 1, the extending direction of each of the connection portions 37 and 38 is a direction along the turn portions 31 to 36, more specifically, a direction slightly inclined from the turn portions 31 to 36 when viewed from the Z direction. According to such connection portions 37 and 38, the change of the current route at the junction portion between the turn portions 31 to 36 and the connection portions 37 and 38 becomes gentle. When the current route at the junction portion changes abruptly (for example, by 90 degrees), a large signal loss may occur at the junction portion, and in this case, a Q value may be decreased. In the multilayer inductor 1, the current routes at the junction portion between the turn portions 31 to 36 and the connection portions 37 and 38 are gently changed, and signal loss at the junction portion is reduced. Therefore, a high Q value can be achieved.

The coil conductor 30 of the multilayer inductor 1 has two connection portions 37 and two connection portions 38, and the connection portions 37 and the connection portions 38 are alternately arranged in the extending direction of the coil axis C. In other words, in the coil conductor 30, in the extending direction of the coil axis C, the connection between the inner peripheral coil portions by the connection portions 37 (that is, the connection between the end portions of the second coil portions) and the connection between the outer peripheral coil portions by the connection portions 38 (that is, the connection between the end portions of the first coil portions) are alternately repeated. In the coil conductor 30 of the multilayer inductor 1, both end portions 30a and 30b are extracted from first coil portions 41 and 46 constituting a part of the outer peripheral coil portions 40. Since both end portions of the coil conductor 30 are constituted by the outer peripheral coil portions 40 as described above, the inner diameter of the coil is increased, and the range of acquirable inductance can be maximized.

Although the coil conductor 30 of the multilayer inductor 1 has six tiers of turn portions 31 to 36, the number of tiers of the turn portions can be increased or decreased as appropriate, and the coil conductor 30 may have at least two tiers of turn portions. When the coil conductor 30 has three tiers of turn portions, the coil conductor 30 has two connection portions (i.e., a connection portion 37 and a connection portion 38). In a case where the coil conductor 30 has four or more tiers of turn portions, the coil conductor 30 has three or more connection portions 37 and 38, and the connection portions 37 and the connection portions 38 are alternately arranged in the extending direction of the coil axis C.

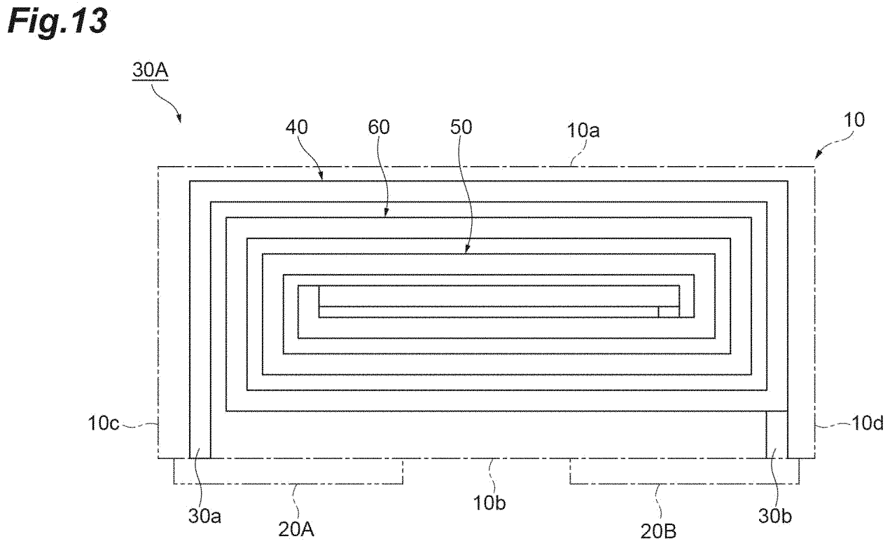

The coil conductor 30 of the multilayer inductor 1 described above has a double winding structure. When the coil conductor 30 has a double winding structure, a higher inductance can be obtained compared to a single winding structure. The coil conductor 30 is not limited to a double winding structure, and may be a coil conductor having a multiple winding structure of triple winding or more. FIG. 13 shows a coil conductor 30A having a triple winding structure. The coil conductor 30A includes intermediate coil portions 60 wound between the outer peripheral coil portions 40 and the inner peripheral coil portions 50 in addition to the outer peripheral coil portions 40 wound on the outer peripheral side and the inner peripheral coil portions 50 wound on the inner peripheral side when viewed from the extending direction of the coil axis C. Similarly to the turn portions 31 to 36 of the coil conductor 30 described above, in the turn portions of the plurality of tiers constituting the coil conductor 30A, the inner peripheral coil portions are connected to each other by the connection portion 37, and the outer peripheral coil portions are connected to each other by the connection portion 38.

Note that the present disclosure is not limited to the above-described embodiment, and various modifications can be made without departing from the scope of the present disclosure. For example, it is not necessary for all of the turn portions constituting the coil conductor to include both the first coil portion constituting a part of the outer peripheral coil portion and the second coil portion constituting a part of the inner peripheral coil portion, and it is sufficient for at least some of the tiers of turn portions to include both.

What is claimed is:

1. A multilayer inductor comprising:
an element body having a multilayer structure in which a plurality of insulating layers are laminated and having a mounting surface parallel to the insulating layers;
a pair of terminal electrodes provided on the mounting surface of the element body; and
a coil conductor provided in the element body, the coil conductor having a coil axis parallel to the mounting surface and having both end portions exposed from the mounting surface and electrically connected to the pair of terminal electrodes,
wherein the coil conductor includes an outer peripheral coil portions wound on an outer peripheral side and an inner peripheral coil portions wound on an inner peripheral side when viewed from an extending direction of the coil axis, and the outer peripheral coil portions and the inner peripheral coil portions are alternately wound in the coil conductor, and
wherein the coil conductor includes a plurality of tiers of turn portions arranged along the coil axis, and at least some of the tiers of the turn portions are located in a plane perpendicular to the coil axis and include a first coil portion constituting a part of the outer peripheral coil portions and a second coil portion constituting a part of the inner peripheral coil portions, and
wherein the end portions of the first coil portions and the end portions of the second coil portions of adjacent tiers of the turn portions are shifted from each other in a direction parallel to the mounting surface when viewed from the extending direction of the coil axis, and
wherein the coil conductor further includes a connection portion linearly extending between the end portions of the first coil portions or between the end portions of the second coil portions of adjacent tiers of the turn portions and connecting the end portions to each other.

2. The multilayer inductor according to claim 1, wherein the coil conductor has three or more tiers of turn portions and has a plurality of connection portions connecting the end portions of the first coil portions or the end portions of the second coil portions of adjacent tiers of the turn portions.

3. The multilayer inductor according to claim 1, wherein a shift amount of both end portions of the connection portion is 1 to 3 times a length of the turn portion in the extending direction of the coil axis.

4. The multilayer inductor according to claim 1, wherein each of both end portions of the coil conductor extends from the outer peripheral coil portions and reaches the mounting surface.
